(19) United States
(12) Patent Application Publication
(10) Pub. No.: US 2010/0154756 A1
(43) Pub. Date: Jun. 24, 2010

(54) SUPERCHARGING DEVICE

(76) Inventor: Chien-Huo Chien, Banqiao City (TW)

Correspondence Address: Anthony R. Barkume, 20 Gateway Lane, Manorville, NY, 11949, US

(21) Appl. No.: 12/624,578

(22) Filed: Nov. 24, 2009

(30) Foreign Application Priority Data
Dec. 18, 2008 (TW) 097222793

(51) Int. Cl. F02B 33/34

(52) U.S. Cl. 123/559.1; 415/220

(57) ABSTRACT

The present invention relates to a kind of supercharging device, which comprises: One frame body, which is being formed into a shape of cylindrical tube, has one primary end and one secondary end respectively, wherein the port of said primary end is being formed into the serrated shape along with a plurality of serration structures, however, the port of said secondary end has a smooth plane instead; one axial structure is being formed into the said frame body; there is also a plurality of blades, in which, each blade being formed into a trapezoidal-shaped blade has a upper plate and a lower plate respectively, therein the said upper plate is shorter than the said lower plate; in addition, the said plurality of blades and the said plurality of serration structures have been formed into the same number, and the upper plate of each blade is being connected to each of the said axial structure, the lower plate is being connected to internal surface within the said frame body, and it is extended from the secondary end to the peak portion of said serration structure of the said primary end, and each of blade is corresponding to each of serration structure; wherein, the said supercharging device will be able to supercharge intake air and hence to improve the said engine's horsepower by enlarging air inflow of the engine.

### BACKGROUND OF THE INVENTION

1. Field of the Invention

The present invention relates to a kind of supercharging device, particularly to the supercharging device installed within an air-intake channel positioned between the engine and the air cleaner, which is capable of improving air inflow of the said engine consequently.

2. The Prior Art

FIG. 1 is a schematic view showing a known natural aspiration type engine, in which, it consists of one engine 11, air-intake channel 12 and air cleaner 13. The known engine 11 adopts a method of natural air intake. As shown in FIG. 1, the engine 11 is connected with the air cleaner 13 through air-intake channel 12, and by the time when the engine 11 is under the operating conditions, the negative pressure generated by internal cylinder piston will inhale the air. Thereby, the airstream will enter into air-intake channel 12 via the air cleaner 31 and it will mix together with gasoline within the engine after filtration, and then the oil and gas maintaining in proper proportion will be ignited in a combustion chamber inside the engine 11 to generate power consequently. However, supposed that an engine adopts the known automated method of natural aspiration, it would inhale the air with the negative pressure generated inside the engine, and in this way the air inflow was insufficient, particularly, when a vehicle traveling in a low pressure environment or when an old vehicle is facing a problem of worn out parts, the problem of insufficient air inflow will become much more serious, so it will lead to an incomplete combustion and hence weaken the engine's power output.

The known supercharging device is being installed within the air-intake channel linking between the engine and air cleaner. Normally, it is constructed into a structure of circular tube, wherein, four blades are manually welded within the said tube and formed into four spiral channels. Therefore, while air inflow is being inhaled due to the negative pressure generated inside the engine, air inflow in the air-intake channel will enter into four spiral channels of the known supercharging device, and achieving the supercharging effect with the fraction effect of said spiral channels so as to enlarge the air inflow. Though the known supercharging device still can achieve a supercharging effect, however, its structure having manually welded blades seem not stable enough, moreover, its accuracy is highly subject to the quality of manual welding operations. In addition, the high expense of manual welding operations would even more increase its overall production cost.

The disadvantages of known technique are summarized as follows:

1. The known natural aspiration type engine typically inhale the air by means of the negative pressure generated inside the engine, therefore, it tends to a shortage of air inflow in the engine;

2. The known natural aspiration type engine tends to a phenomenon of insufficient air inflow and hence it would lead to a weakened engine's power output due to incomplete combustion;

3. The known supercharging device adopts the manual welding technology to weld its blade structure, which not only would result in an unstable structure but also would have a lower accuracy due to inconsistent structural quality; and

4. The known supercharging device must pay a high expense for the manual welding operation, which would increase its overall production cost.

Thus, how to improve all disadvantages of known supercharging device as described in the preceding paragraphs in order to have an effective supercharging device having a lower production cost, more stable structure and higher accuracy, are concerns of the present invention.

### SUMMARY OF THE INVENTION

The objective of the present invention lies in providing a innovative and advanced supercharging device, which adopts a specialized structural design to fulfill the supercharging effect on the air inflow, moreover, it is produced by means of the plastic injection molding technology, thereby it not only will be able to upgrade the engine's horsepower but also having additional advantages such as more stable, higher accuracy etc., but also will effectively reduce the necessary production costs as well.

To fulfill the above objectives, thus, the present invention provides a kind of supercharging device, which comprises:

One frame body, which is being formed into a shape of cylindrical tube, has one primary end and one secondary end respectively, wherein the port of said primary end is being formed into the serrated shape along with a plurality of serration structures, and the port of said secondary end has a smooth plane instead;

One axial structure is being formed into the said frame body;

A plurality of blade, in which, each blade being formed into a trapezoidal-shaped blade has a upper plate and a lower plate respectively, therein the said upper plate is shorter than the said lower plate; in addition, the said plurality of blades and the said plurality of serration structures have been formed into the same number, and the upper plate of each blade is being connected to each of the said axial structure, the lower plate is being connected to internal surface within the said frame body, thereat it is extended from the secondary end to the peak portion of said serration structure of the said primary end, and each of blade is corresponding to each of serration structure;

Wherein, the said supercharging device will be able to supercharge intake air and hence to improve the said engine's horsepower by enlarging air inflow of the engine.

A supercharging device as defined in the preceding paragraph, which is being installed at a position connecting to the said engine and an air cleaner.

A supercharging device as defined in the preceding paragraph, wherein, one air-intake channel is being equipped between the said engine and the said air cleaner, and the said supercharging device is being constructed into the said air-intake channel.

A supercharging device as defined in the preceding paragraph, wherein, air flow exhausted through the said air cleaner would flow into the said supercharging device via the said secondary end of said frame body, and in addition, airstream would be exhausted from the said primary end and then entering into the said engine.

A supercharging device as defined in the preceding paragraph, wherein, the said axial structure is being constructed into a cylindrical tube.

A supercharging device as defined in the preceding paragraph, wherein it is produced by means of the plastic injection molding technology.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing a known natural aspiration type engine;

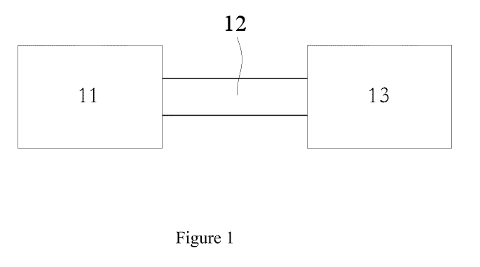

FIG. 2 is a schematic view showing the supercharging device in accordance with one preferred embodiment of the present invention; and

FIG. 3 is a schematic view showing the connecting method for the supercharging device in accordance with one preferred embodiment of the present invention.

### DETAILED DESCRIPTION OF THE PREFERRED EMBODIMENT

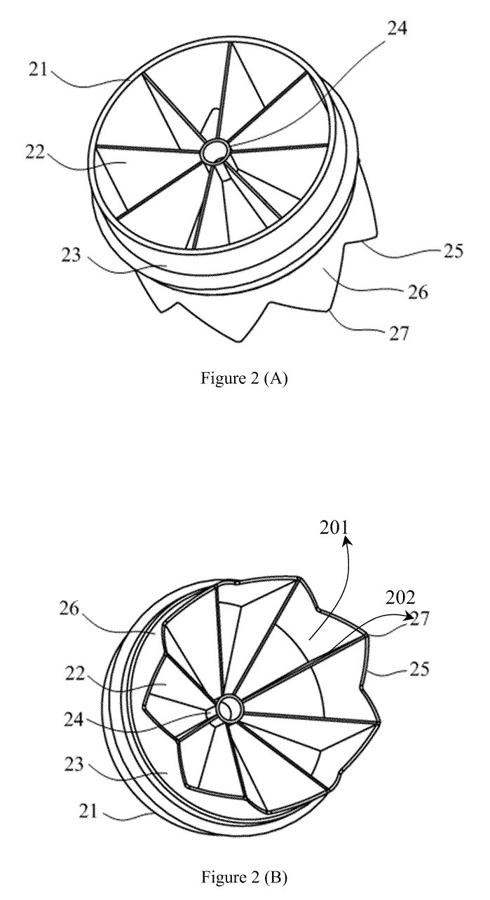

FIG. 2 is a schematic view showing the supercharging device in accordance with one preferred embodiment of the present invention, which comprises the secondary end 21, blade 22, frame body 23, axial structure 24, primary end 25, serration structure 26 and peak portion 27. The supercharging device provided by the present invention mainly consists of frame body 23, axial structure 24 and a plurality of blades 22. Whereat, the frame body 23 is being formed into a shape of cylindrical tube, and the port of primary end 25 of frame body 23 is being formed into a serration shape comprising a plurality of serration structure 26; however, the port of secondary end 21 of the frame body 23 is being formed into a smooth plane instead. There is axial structure 24 being constructed at the axis portion of the frame body 23, and a plurality of blades 22 are being connected to both the frame body 23 and axial structures 24. Wherein, blade 22 is being formed into a trapezoidal-shaped blade, which comprises the upper plate and lower plate, and thereat, the length of upper plate is shorter than that of lower plate. Furthermore, blade 22 and serration structure 26 have been formed into the same number, and the upper plate of each blade 22 is being connected to each of the said axial structure 24, and the lower plate is being connected to internal surface within the said frame body 23, wherein, the position where lower plate of said blade 22 connecting to the frame body 23 is actually connected to the peak portion 27 of serration structure 26 and thereat the lower plate is extended from the secondary end 21 of frame body 23 to the peak portion 27 of said serration structure 26 of the said primary end 25, and each of blade 22 is corresponding to each of serration structure 26. By the time while airstream is being exhausted from the secondary end 25, a “V” portion consisting of two serration structures 26 will be able to divide the airstream into two flow fields 201, 202, and hence facilitating the pressurization effect of airstream consequently.

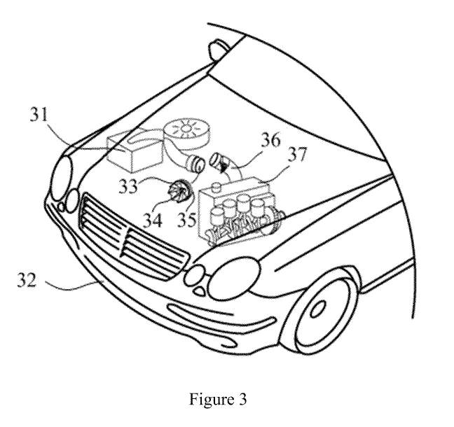

FIG. 3 is a schematic view showing the connecting method for the supercharging device in accordance with one preferred embodiment of the present invention, in which, it consists of the air cleaner 31, vehicle 32, supercharging device 33, primary end 34, secondary end 35, air-intake channel 36 as well as engine 37. The supercharging device provided by the present invention is being installed within the air-intake channel 36 between the engine 37 of a vehicle 32 and air cleaner 31. When the engine 37 is under normal operating condition, negative pressure generated inside the engine will inhale the air, thereby, the airstream will enter into air-intake channel 36 via air cleaner 31 and then it will enter into the supercharging device 33 through the secondary end 35. Having a specialized structural design, thus, the supercharging device 33 presented by the present invention is able to fulfill the supercharging effect on the air inflow, under this circumstance, therefore, the airstream exhausted from the primary end 34 would be pressurized firstly and then entering into the engine 37. Thus, the pressurized airstream will improve the horsepower of the engine 37 by achieving an effect of complete combustion.

The supercharging device introduced by the present invention can be produced by means of the plastic injection molding technology, in which, the overall structure of the said supercharging device can be made with the extrusion molds, whereby, the frame body and blades can be formed into all-in-one structure that not only is more stable than common structure but also has higher accuracy than others. Under this circumstance, it will be able to upgrade the engine's performance up to 40% while using the supercharging device provided by the present invention. Besides, the supercharging device presented by the present invention would force the fresh air entering into the engine under high-pressure conditions, which would facilitate the improvement of engine's horsepower with complete combustion in addition to an additional effect of oil consumption up to 20%, where it will protect the engine and decrease the carbon accumulation so as to increase the engine's service life and facilitating the starting of a vehicle. Certainly, the supercharging device introduced by the present invention can be applied to various kinds of engines.

The advantages of the present invention comprise as follows:
1. The supercharging device presented by the present invention can force the fresh air entering into the engine under high-pressure conditions, which would facilitate the improvement of engine's horsepower with complete combustion thereof;
2. The supercharging device introduced by the present invention can be produced by means of the plastic injection molding technology, in which, the frame body and blades can be formed into all-in-one structure that not only is more stable than common structure but also has higher accuracy than others;
3. The supercharging device provided by the present invention has a specialized structural design which does not require any manual welding process at all so that it can effectively reduce the production costs;
4. The supercharging device presented by the present invention not only can upgrade the engine's horsepower, even more it can achieve an effect of oil consumption, where it will protect the engine and decrease the carbon accumulation so as to increase the engine's service life and facilitating the starting of a vehicle; and
5. The supercharging device presented by the present invention can facilitate the complete combustion effect for the engine which will make the vehicle not to emit visible emissions and complying with the concept of environmental protection.

From the foregoing description, the supercharging device provided by the present invention utilizes a specialized structural design to achieve the effect of supercharging on air flow, in addition, it can be produced by means of the plastic injection molding technology, where the frame body and blades can be formed into all-in-one structure that not only is more stable than common structure but also has higher accuracy than others, under this circumstance, this innovative and advanced supercharging device can effectively reduce the production costs, and meanwhile it can be applied to various kinds of applications with alternative designing from time to time, for instance, it can be applied to various kinds of engines, additional blades, or different shape of the serration structure etc., wherein the variety of modifications and changes may be made without departing from the scope of the present invention which is intended to be defined by the appended claims as long as it is the frame body has a serration structure and its blades are connected to the peak portion of the said serration structure thereof.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A supercharging device, which comprises:
one frame body, which is being formed into a shape of cylindrical tube, has one primary end and one secondary end respectively, wherein the port of said primary end is being formed into the serrated shape along with a plurality of serration structures;
one axial structure is being formed into the said frame body;
a plurality of blades, in which, each blade being formed into a trapezoidal-shaped blade has a upper plate and a lower plate respectively, therein the said upper plate is shorter than the said lower plate; in addition, the said plurality of blades and the said plurality of serration structures have been formed into the same number, and the upper plate of each blade is being connected to each of the said axial structure, the lower plate is being connected to internal surface within the said frame body, thereat it is extended from the secondary end to the peak portion of said serration structure of the said primary end, and each of blade is corresponding to each of serration structure;
wherein, the said supercharging device will be able to supercharge intake air and hence to improve the said engine's horsepower by enlarging air inflow of the engine.

2. A supercharging device as defined in claim 1, which is being installed at a position connecting to the said engine and an air cleaner.

3. A supercharging device as defined in claim 2, wherein, one air-intake channel is being equipped between the said engine and the said air cleaner, and the said supercharging device is being constructed into the said air-intake channel.

4. A supercharging device as defined in claim 2, wherein, air flow exhausted through the said air cleaner would flow into the said supercharging device via the said secondary end of said frame body, and in addition, airstream would be exhausted from the said primary end and then entering into the said engine.

5. A supercharging device as defined in claim 1, wherein, the said axial structure is being constructed into a cylindrical tube.

6. A supercharging device as defined in claim 1, wherein it is produced by means of the plastic injection molding technology.
